(19) United States
(12) Patent Application Publication
(10) Pub. No.: US 2016/0167292 A1
(43) Pub. Date: Jun. 16, 2016

(54) Continuous Manufacture Of Expanded Honeycomb Blocks

(71) Applicant: Gosakan Aravamudan, Bangalore (IN)

(72) Inventor: Gosakan Aravamudan, Bangalore (IN)

(21) Appl. No.: 14/967,381

(22) Filed: Dec. 14, 2015

(30) Foreign Application Priority Data
Dec. 16, 2014 (IN) 6329/CHE/2014

(51) Int. Cl. B29C 65/00; B29C 70/44

(52) U.S. Cl. CPC B29C 66/7254; B29C 70/443; B29C 66/0222

(57) ABSTRACT

An apparatus and a method for a continuous manufacture of an expanded composite honeycomb block are provided. Resin impregnated fibers are deposited on a conformable thin membrane that moves over a heated bed with a corrugated surface. A vacuum is applied between the conformable thin membrane and the heated bed to conform the resin impregnated fibers to the shape of the corrugated surface of the heated bed. A stacker is lowered to contact the corrugated resin impregnated fibers on top nodes of the corrugated surface of the heated bed. The corrugated resin impregnated fibers are heat cured. The stacker is raised to lift the heat cured corrugated resin impregnated fibers after the corrugated resin impregnated fibers release from the conformable thin membrane. The above steps are repeated until the stacker stacks layers of the corrugated resin impregnated fibers to a desired thickness to manufacture the expanded composite honeycomb block.

### CROSS-REFERENCE TO RELATED APPLICATIONS

This application claims priority to and the benefit of provisional patent application number 6329/CHE/2014 titled “CONTINUOUS MANUFACTURE OF EXPANDED HONEYCOMB BLOCKS”, filed in the Indian Patent Office on Dec. 16, 2014, and non-provisional patent application number 6329/CHE/2014 titled “CONTINUOUS MANUFACTURE OF EXPANDED HONEYCOMB BLOCKS”, filed in the Indian Patent Office on Dec. 11, 2015. The specifications of the above referenced patent applications are incorporated herein by reference in their entirety.

### BACKGROUND

The apparatus and method disclosed herein, in general, relates to honeycomb manufacturing, and more particularly, relates to manufacturing expanded composite honeycomb blocks in a continuous process.

Composite honeycomb blocks are typically manufactured by corrugation, expansion and molding processes. As used herein, “composite” refers to a material comprising reinforcing synthetic fibers in a resin matrix. These composite honeycomb blocks are then sliced to a required height to be used as a honeycomb in sandwich structures and panels.

In a conventional corrugation process, thin metal or composite sheets are first corrugated. An additional step of applying a node adhesive to peaks of the corrugated sheets is then needed, and each corrugated sheet needs to be moved to a precise position for stacking, pressing, and curing. Hence, in a conventional corrugation process, the steps of corrugation and node bonding are sequential discrete processes.

In a conventional expansion process, stacks of dry thin metal or composite sheets are attached at node points with a node adhesive, and a complex method of expansion is performed prior to repeated dips of the stacks of sheets in a resin tank following curing. Hence, the conventional expansion process for manufacturing honeycombs is a multistep batch process.

In a conventional molding process for manufacturing composite honeycomb blocks, a resin impregnated fiber sheet is pressed between two layers that are shaped according to requirements, and then cured to a shape and a form defined by the two layers. In this case, the two layers can both be rigid surfaces or one of the two layers can be a flexible membrane and the other layer can be a shape-defining rigid structure. Hence, in the conventional molding process for manufacturing composite honeycomb blocks, the resin impregnated fiber sheet is covered on both surfaces by either a rigid mold or one or more flexible membranes. After the resin impregnated fiber sheet is cured between the two layers into a corrugated shape, an additional discrete step of applying a node adhesive to peaks of the corrugated resin impregnated fiber sheet is needed, and each corrugated resin impregnated fiber sheet needs to be moved to a precise position for stacking, pressing, and curing.

In another conventional molding process, resin impregnated fiber sheets are cured between stacks of mandrels to manufacture a composite honeycomb block. After curing, the mandrels are removed. This process of positioning mandrels and then later releasing the mandrels from the cured composite honeycomb block is a time consuming and unreliable process. The mandrels may occasionally get misaligned or may get fastened to the cured composite honeycomb block. In this conventional molding process, an upper surface and a lower surface of the resin impregnated fiber sheet make direct contact with a top mandrel and a bottom mandrel respectively.

The above conventional processes of corrugation, expansion, and molding are either unreliable or are multistep processes that reduce throughput and increase the cost. Hence, there is a long felt but unresolved need for an apparatus and a method for a continuous manufacture of expanded composite honeycomb blocks in a single stage operation. Furthermore, there is an unmet need for eliminating the additional step of applying node adhesives to peaks of corrugated composite sheets for stacking, pressing, and curing of the corrugated composite sheets.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended to determine the scope of the claimed subject matter.

The apparatus and the method disclosed herein address the above mentioned needs for a continuous manufacture of expanded composite honeycomb blocks in a single stage operation. The method disclosed herein is hereafter referred to as an “inverse pull molding” process. The apparatus and the method disclosed herein eliminate an additional step of applying node adhesives to peaks of corrugated composite sheets for stacking, pressing, and curing of the corrugated composite sheets.

The apparatus disclosed herein comprises a heated bed with a corrugated surface, a conformable thin membrane, a vacuum pump, and a stacker positioned above the heated bed. The vacuum pump is in fluid communication with a space between the heated bed and the conformable thin membrane via a vacuum port. In the inverse pull molding process disclosed herein, resin impregnated fibers are iteratively deposited on the conformable thin membrane that moves over the heated bed with the corrugated surface. The upper surface of the resin impregnated fibers is exposed to air and a lower surface of the resin impregnated fibers is in flush contact with the conformable thin membrane. Upon application of a vacuum between the conformable thin membrane and the heated bed, the conformable thin membrane along with the resin impregnated fibers is pulled towards the corrugated surface of the heated bed, and therefore the conformable thin membrane with the resin impregnated fibers conforms to a shape of the corrugated surface of the heated bed, thereby creating corrugated resin impregnated fibers. The stacker is lowered to contact and adhere to the corrugated resin impregnated fibers on top nodes of the corrugated surface of the heated bed. The corrugated resin impregnated fibers are then heat cured. The stacker is raised to lift the heat cured corrugated resin impregnated fibers after the heat cured corrugated resin impregnated fibers release from the conformable thin membrane. The above steps are repeated until the stacker stacks layers of the heat cured corrugated resin impregnated fibers to a desired thickness to manufacture an expanded composite honeycomb block of the desired thickness.

The inverse pull molding process disclosed herein differs from a conventional composite honeycomb molding process in that the upper surface of uncured resin impregnated fibers is exposed, while the lower surface of the uncured resin impregnated fibers that is proximal to the conformable thin membrane is pulled towards the corrugated surface of the heated bed. The tacky upper surface of the uncured resin impregnated fibers is then bonded to the previously stacked layers of the corrugated resin impregnated fibers. The tackiness of the lower surface of the resin impregnated fibers ensures a temporary adhesion between the resin impregnated fibers and the conformable thin membrane while the vacuum is applied. Multiple layers of cured corrugated resin impregnated fibers are stacked to create an expanded composite honeycomb block. In the inverse pull molding process disclosed herein, the stacking process occurs simultaneously while the resin in the corrugated resin impregnated fibers is being heat cured. In this simultaneous stacking process, the uncured resin on the top of the ridges of the corrugated resin impregnated fibers acts as a node adhesive to attach to the stack of cured corrugated resin impregnated fibers that is held above by the stacker.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods, structures, and components disclosed herein. The description of a method step or a structure or a component referenced by a numeral in a drawing is applicable to the description of that method step or structure or component shown by that same numeral in any subsequent drawing herein.

FIG. 1 exemplarily illustrates a side perspective view of an apparatus for a continuous manufacture of an expanded composite honeycomb block using an inverse pull molding process.

FIG. 2 exemplarily illustrates a rear elevation view of the apparatus for the continuous manufacture of an expanded composite honeycomb block using the inverse pull molding process.

FIG. 3 exemplarily illustrates a top plan view of the apparatus for the continuous manufacture of an expanded composite honeycomb block using the inverse pull molding process.

FIG. 4 illustrates an inverse pull molding process for a continuous manufacture of an expanded composite honeycomb block.

FIGS. 5A-5F exemplarily illustrate side elevation views of a partial section of the apparatus for a continuous manufacture of an expanded composite honeycomb block, showing a stacking operation performed in the continuous manufacture of the expanded composite honeycomb block.

FIG. 6 exemplarily illustrates a side elevation view of an expanded composite honeycomb block created by the stacking operation shown in FIGS. 5A-5F.

### DETAILED DESCRIPTION OF THE INVENTION

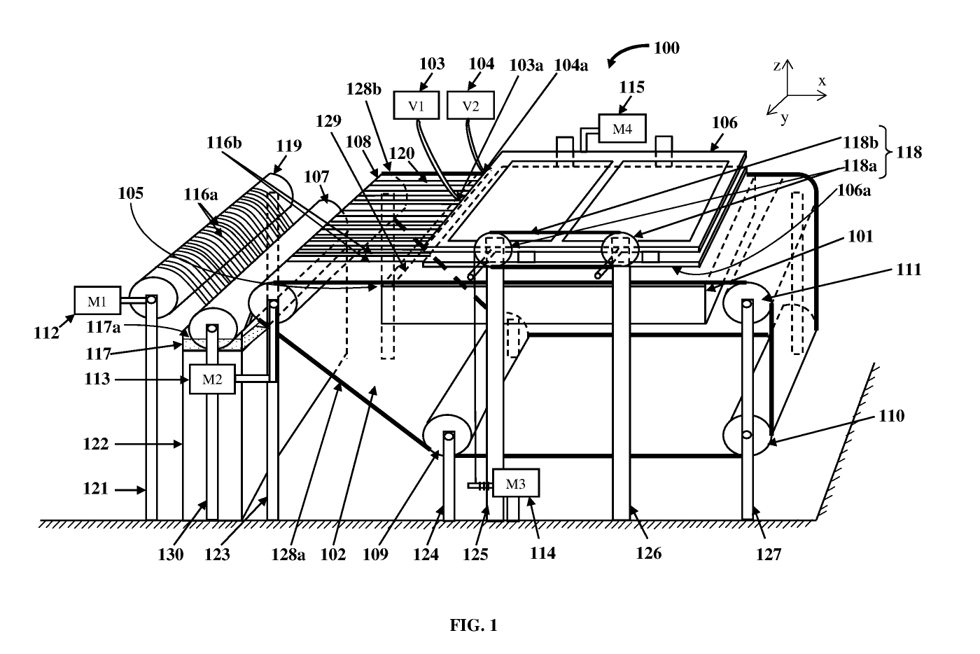

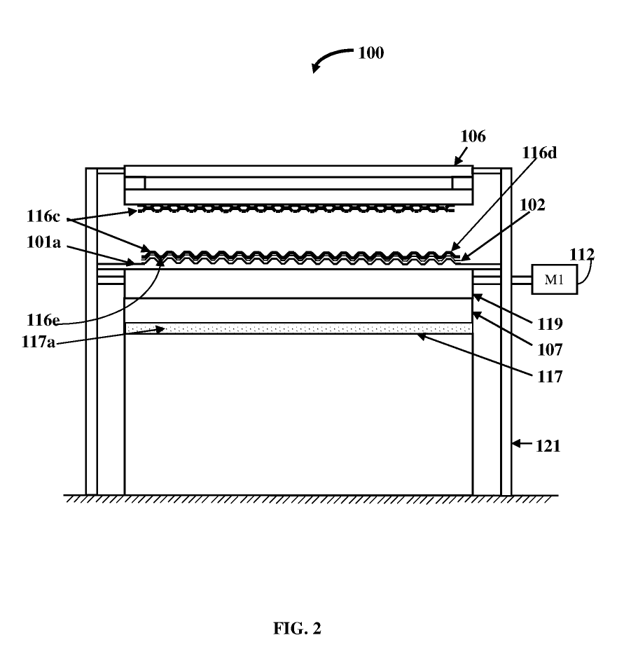

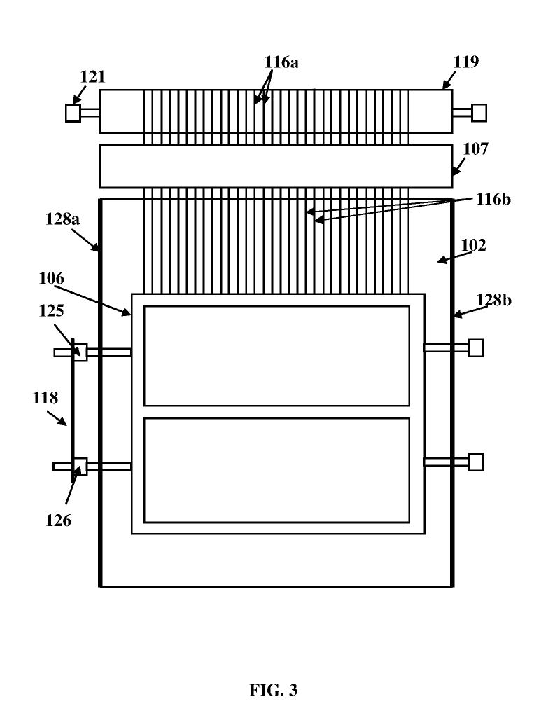

FIG. 1, FIG. 2, and FIG. 3 exemplarily illustrate a side perspective view, a rear elevation view, and a top plan view respectively, of an apparatus 100 for a continuous manufacture of an expanded composite honeycomb block using an inverse pull molding process. As used herein, “expanded composite honeycomb block” refers to a composite honeycomb block with a cell structure that is in its final expanded form. The apparatus 100 disclosed herein comprises a heated bed 101 with a corrugated surface 101a exemplarily illustrated in FIG. 2, and a slit cavity 129 adjacent or proximal to the corrugated surface 101a, a conformable thin membrane 102, vacuum pumps V1 103 and V2 104, and a stacker 106. The apparatus 100 disclosed herein further comprises a beam 119, moving conveyor belts 128a and 128b guided by rollers 108, 109, 110, and 111, a transfer roller 107, a resin tank 117, control motors 112, 113, 114, and 115, and a pulley system 118 as exemplarily illustrated in FIG. 1. The beam 119 is held by a support 121. The rollers 108 and 109 are held in position by supports 123 and 124 respectively. The rollers 110 and 111 are held in position by a support 127.

Fibers 116a used in the continuous manufacture of the expanded composite honeycomb block comprise, for example, one or a combination of glass fibers, carbon fibers, aramid fibers, thermoplastic fibers, etc. In an embodiment, the fibers 116a are spread tow fibers than can be easily wetted by a resin, for example, 117a. The resin 117a contained in the resin tank 117 is, for example, a phenolic resin, an epoxy resin, a polyimide resin, a cyanate ester resin, a bismaleimide resin, a polyester resin, or one of other thermoset resins. A support wall 122 supports the resin tank 117. The vacuum pumps V1 103 and V2 104 are in fluid communication with a space 105 between the heated bed 101 and the conformable thin membrane 102 via vacuum ports 103a and 104a respectively. In an embodiment, the conformable thin membrane 102 is a thin silicone rubber sheet. In another embodiment, the conformable thin membrane 102 is a thin silicone rubber sheet reinforced with unidirectional fibers, where the unidirectional fibers comprise one or a combination of glass fibers, carbon fibers, aramid fibers, thermoplastic fibers, etc. The conformable thin membrane 102 is laterally attached to the moving conveyor belts 128a and 128b. The rollers 108, 109, 110, and 111 are connected by the moving conveyor belts 128a and 128b. The transfer roller 107 is held in position in the resin tank 117 by a support 130. In an embodiment, the transfer roller 107 partially immersed in the resin 117a contained in the resin tank 117 is rotationally coupled to the roller 108.

In an embodiment, a tacky prepreg is directly placed on the conformable thin membrane 102. An example of a prepreg is a phenolic resin impregnated unidirectional glass fiber that is B-stage cured. A B-stage is created when a formulation, having the appropriate stoichiometry for a full cure, is held at an intermediate stage by cooling. In an embodiment, the heated bed 101 is a metal bed with a corrugated surface 101a as exemplarily illustrated in FIG. 2, that creates peaks and valleys in the expanded composite honeycomb block. In an embodiment, the heated bed 101 is, for example, an aluminum sheet with a corrugated surface 101a. In another embodiment, the heated bed 101 is, for example, a steel sheet on which inverted approximately semi-hexagonal shaped long metal sections are attached using an adhesive or welded to create the corrugated surface 101a. The corrugated surface 101a is located at the top of the heated bed 101 as exemplarily illustrated in FIG. 1. There is a silicone rubber seal (not shown) on the top of the heated bed 101 that surrounds a periphery of the corrugated surface 101a of the heated bed 101. The lower surface of the conformable thin membrane 102 is in continuous surface contact with the silicon rubber seal. The shape of the corrugated surface 101a of the heated bed 101 defines the shape of cells of the expanded composite honeycomb block to be manufactured. The stacker 106 comprising a lower attachment surface 106a is positioned above the heated bed 101 and is capable of moving in a “y” direction and a “z” direction. Movement of the stacker 106 in the “z” direction is performed, for example, using the pulley system 118. The pulley system 118 comprising gears 118a and a chain 118b is supported by supports 125 and 126. The control motors 112, 113, 114, and 115 are, for example, stepper motors.

The control motor M1 112 drives the beam 119. The rollers 108, 109, 110, and 111 guide the moving conveyor belts 128a and 128b. The control motor M2 113 drives one of the rollers, for example, the roller 108. The beam 119 driven by the control motor M1 112 conveys fibers 116a placed on the beam 119 to the resin tank 117. The conveyed fibers 116a are immersed in the resin 117a contained in the resin tank 117. The excess resin is squeezed out and the resin impregnated fibers 116b are pulled onto the conformable thin membrane 102 by the roller 108 via the transfer roller 107. In an embodiment, the movement of the control motor M1 112 and the control motor M2 113 is synchronized to allow the resin impregnated fibers 116b to maintain constant tension. In an embodiment, additional cross reinforcing fibers, for example, chopped short fibers or continuous low tex fibers, are deposited in an area 120 on the conformable thin membrane 102 to improve shear strength of the resin impregnated fibers 116b in the “y” direction. In an embodiment, the resin 117a is deposited from the transfer roller 107 on the conformable thin membrane 102, and then the fibers 116a are guided from the beam 119 and deposited directly on the resin coated conformable thin membrane 102. The conformable thin membrane 102, guided by the rollers 108, 109, 110, and 111 moves in an “x” direction over the heated bed 101, proximal to the corrugated surface 101a of the heated bed 101.

When the resin impregnated fibers 116b are conveyed to a position below the stacker 106 by the moving conveyor belts 128a and 128b, the control motor M2 113 stops the movement of the conformable thin membrane 102. The vacuum pump V1 103 applies a vacuum via the vacuum port 103a to iteratively pull the conformable thin membrane 102 along with the resin impregnated fibers 116b on the corrugated surface 101a of the heated bed 101 to allow the conformable thin membrane 102 with the resin impregnated fibers 116b to conform to a shape of the corrugated surface 101a of the heated bed 101 and create corrugated resin impregnated fibers 116c. The corrugated resin impregnated fibers 116c begin to cure on the heated bed 101. The control motor M3 114 lowers the stacker 106 in the “z” direction using the pulley system 118 to allow the lower attachment surface 106a of the stacker 106 to contact the curing corrugated resin impregnated fibers 116c.

After the curing of the resin 117a of the corrugated resin impregnated fibers 116c on the heated bed 101, the vacuum pump V2 104 is activated. The silicone rubber seal on the top of the heated bed 101 creates an airtight cavity for vacuum creation. The vacuum pump V2 104 pulls the conformable thin membrane 102 downwards into the slit cavity 129 of the heated bed 101, thereby exposing the corrugated resin impregnated fibers 116c for a cutting operation. A rotary cutter (not shown) cuts the cured corrugated resin impregnated fibers 116c in the “y” direction. The vacuum pump V2 104 is then deactivated. The stacker 106 is then raised in the “z” direction and thereby the cut and cured corrugated resin impregnated fibers 116c adhere to the stacker 106 and are lifted up by the stacker 106. The control motor M4 115 drives, for example, a ball screw to shift the stacker 106 in the “y” direction by a distance equal to approximately half a cell pitch of the corrugated surface 101a of the heated bed 101. As used herein, “cell pitch” refers to a distance between two peaks of the corrugated surface 101a of the heated bed 101.

In a simultaneous node bonding process, the uncured resin on the top of the ridges of the corrugation formed at the cut and cured corrugated resin impregnated fibers 116c acts as a node bond adhesive to attach to the stacker 106 to form a first layer of a stack of the cured corrugated resin impregnated fibers 116c that form the expanded composite honeycomb block. The stacker 106 is configured to be lowered iteratively to adhere to and pick up the cut and cured corrugated resin impregnated fibers 116c positioned over the conformable thin membrane 102, whereby the stacker 106 iteratively stacks layers of the cut and cured corrugated resin impregnated fibers 116c to manufacture the expanded composite honeycomb block. Thus, the entire cycle of the inverse pull molding process disclosed above is repeated with further cut and cured corrugated resin impregnated fibers 116c attaching to previous layers of the stack of the cut and cured corrugated resin impregnated fibers 116c that are held under the stacker 106 until the expanded composite honeycomb block of a desired thickness is built under the stacker 106.

FIG. 4 exemplarily illustrates an inverse pull molding process for a continuous manufacture of an expanded composite honeycomb block. The apparatus 100 comprising the heated bed 101 with the corrugated surface 101a, the conformable thin membrane 102, a vacuum pump V1 103, and a stacker 106 as exemplarily illustrated in FIGS. 1-3 and as disclosed in the detailed description of FIGS. 1-3, is provided. In the method disclosed herein, resin impregnated fibers 116b are deposited 401 on the conformable thin membrane 102. An upper surface 116d of the resin impregnated fibers 116b is exposed to air and a lower surface 116e of the resin impregnated fibers 116b is in flush contact with the conformable thin membrane 102 as exemplarily illustrated in FIG. 2. The conformable thin membrane 102 along with the resin impregnated fibers 116b is moved 402 over the heated bed 101, proximal to the corrugated surface 101a of the heated bed 101. A vacuum is applied 403 between the conformable thin membrane 102 and the heated bed 101 for pulling the conformable thin membrane 102 along with the resin impregnated fibers 116b on the corrugated surface 101a of the heated bed 101 to allow the conformable thin membrane 102 with the resin impregnated fibers 116b to conform to a shape of the corrugated surface 101a of the heated bed 101 and create corrugated resin impregnated fibers 116c. The stacker 106 is lowered 404 to contact the corrugated resin impregnated fibers 116c on top nodes of the corrugated surface 101a of the heated bed 101. The corrugated resin impregnated fibers 116c are heat cured 405. The stacker 106 is raised 406 to lift the heat cured corrugated resin impregnated fibers 116c after the heat cured corrugated resin impregnated fibers 116c release from the conformable thin membrane 102. The above steps are repeated 407 until the stacker 106 stacks layers of the heat cured corrugated resin impregnated fibers 116c to a desired thickness to manufacture an expanded composite honeycomb block of the desired thickness.

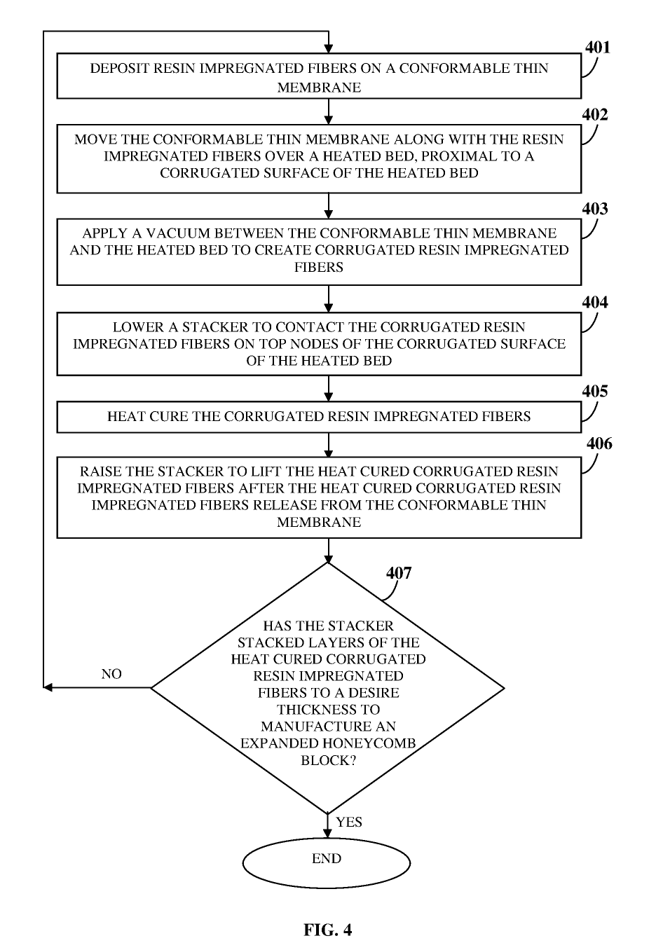

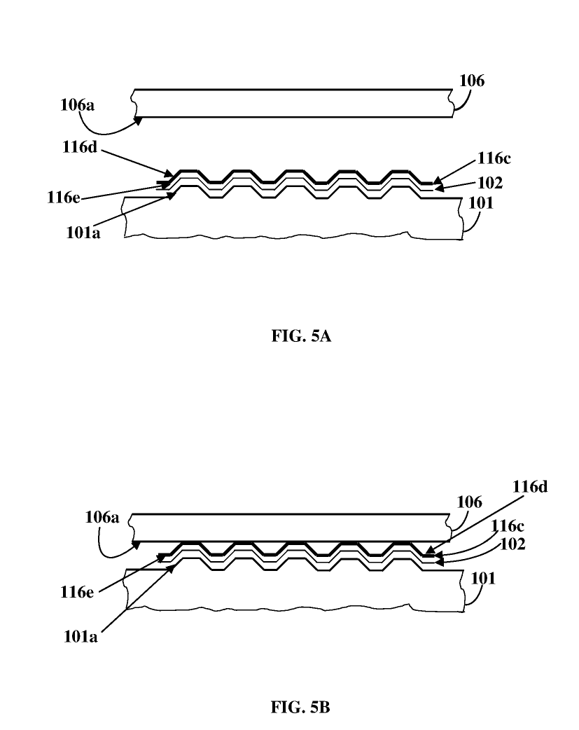

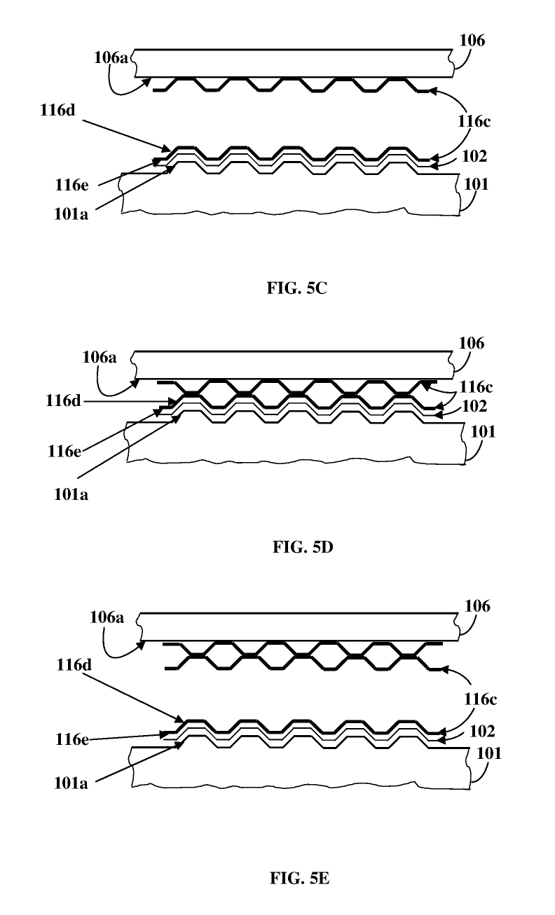

FIGS. 5A-5F exemplarily illustrate side elevation views of a partial section of the apparatus 100 for a continuous manufacture of an expanded composite honeycomb block, showing a stacking operation performed in the continuous manufacture of the expanded composite honeycomb block. To demonstrate the stacking operation, a portion of the heated bed 101 with the corrugated surface 101a, a portion of the stacker 106, and a portion of the conformable thin membrane 102 are shown in FIGS. 5A-5F, along with resin impregnated fibers.

In the first step of the stacking operation, the upper surface 116d of the uncured resin impregnated fibers is exposed, while the lower surface 116e of the uncured resin impregnated fibers proximal to the conformable thin membrane 102 is pulled towards the corrugated surface 101a of the heated bed 101 as exemplarily illustrated in FIG. 5A, to create corrugated resin impregnated fibers 116c. The stacker 106 is positioned above the exposed upper surface 116d of the uncured corrugated resin impregnated fibers 116c.

In the second step of the stacking operation, the stacker 106 is lowered such that the lower attachment surface 106a of the stacker 106 contacts the uncured corrugated resin impregnated fibers 116c as exemplarily illustrated in FIG. 5B. The curing resin in the corrugated resin impregnated fibers 116c adhesively attaches the corrugated resin impregnated fibers 116c to the lower attachment surface 106a of the stacker 106.

In the third step of the stacking operation, the stacker 106 is raised after the curing resin in the corrugated resin impregnated fibers 116c solidifies. The stacker 106 is then offset, for example, by half the cell pitch of the corrugated surface 101a of the heated bed 101 in the “y” direction as exemplarily illustrated in FIG. 5C. A rotating cutter (not shown) cuts the cured corrugated resin impregnated fibers 116c in the “y” direction.

In the fourth step of the stacking operation, the offset stacker 106 is lowered as exemplarily illustrated in FIG. 5D, after the moving conveyor belts 128a and 128b in operable communication with the rollers 108, 109, 110, and 111 exemplarily illustrated in FIG. 1, again pull and position the conformable thin membrane 102 on which the resin impregnated fibers have been laid below the stacker 106. The curing resin in the corrugated resin impregnated fibers 116c adhesively attaches the corrugated resin impregnated fibers 116c to the corrugated form of the previous layer of the cured corrugated resin impregnated fibers 116c that is attached to the stacker 106.

After the completion of the stacking operation exemplarily illustrated in FIG. 5D, in the fifth step of the stacking operation exemplarily illustrated in FIG. 5E, the stacker 106 is raised after the curing resin in the adhesively attached corrugated resin impregnated fibers 116c solidifies to obtain stacked corrugated resin impregnated fibers 116c. The above stacking steps are repeated until layers of the corrugated resin impregnated fibers 116c of a desired thickness are built as exemplarily illustrated in FIG. 5F, to manufacture the expanded composite honeycomb block of the desired thickness.

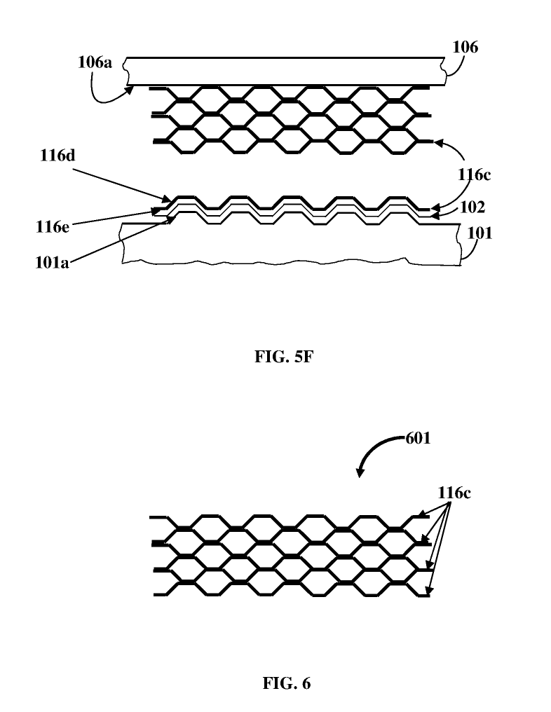

FIG. 6 exemplarily illustrates a side elevation view of an expanded composite honeycomb block 601 created by the stacking operation shown in FIGS. 5A-5F. After the completion of the stacking operation disclosed in the detailed description of FIGS. 5A-5F, the expanded composite honeycomb block 601 is removed from the stacker 106, and can be cut into slices as per customer specifications.

The following example illustrates the working of the apparatus 100 exemplarily illustrated in FIGS. 1-3. Fibers 116a, for example, glass fiber rovings of 100 gsm surface weight are guided from the beam 119 and immersed in a resin 117a, for example, a phenolic resin of approximately 50 grams per square meter (gsm) surface weight contained in the resin tank 117. The excess phenolic resin is squeezed out and the phenolic resin impregnated fibers 116b are pulled onto the conformable thin membrane 102 by the roller 108 via the transfer roller 107. The conformable thin membrane 102 is a silicone rubber sheet. The roller 108 driven by the control motor M2 113 moves the silicone rubber sheet along with the phenolic resin impregnated fibers 116b under the stacker 106 in the “x” direction. Additional cross reinforcing glass fibers of 50 gsm surface weight are deposited in an area 120 on the silicone rubber sheet to improve the shear strength of a resulting expanded composite honeycomb block 601 exemplarily illustrated in FIG. 6. Once the phenolic resin impregnated fibers 116b are positioned under the stacker 106, the control motor M2 113 stops the movement of the silicone rubber sheet. The vacuum pump V1 103 is then activated, whereby the vacuum pump V1 103 makes the silicone rubber sheet with its adhered phenolic resin impregnated fibers 116b and cross reinforcing glass fibers to conform to the corrugated surface 101a of the heated bed 101.

The control motor M3 114 lowers the stacker 106 in the “z” direction to allow the lower attachment surface 106a of the stacker 106 to make contact with the curing corrugated phenolic resin impregnated fibers 116c and cross reinforcing glass fibers. After the curing of the phenolic resin on the heated bed 101, the vacuum pump V1 103 is activated. The vacuum pump V1 103 draws the silicone rubber sheet from the cured corrugated phenolic resin impregnated fibers 116c and cross reinforcing glass fibers. After the corrugated phenolic resin impregnated fibers 116c and cross reinforcing glass fibers cure on the heated bed 101, a rotating cutter (not shown) cuts the cured corrugated phenolic resin impregnated fibers 116c and cross reinforcing glass fibers in the “y” direction along the slit cavity 129 of the heated bed 101. The stacker 106 is then raised in the “z” direction and thereby the cut and cured corrugated phenolic resin impregnated fibers 116c and cross reinforcing glass fibers are adhered to the stacker 106 and lifted up. The control motor M4 115 then shifts the stacker 106 in the “y” direction by a distance equal to, for example, approximately 4.5 mm. The entire cycle of the inverse pull molding process disclosed above is repeated until the expanded composite honeycomb block 601 of a desired thickness is built under the stacker 106. The expanded composite honeycomb block 601 is removed from the stacker 106, and can be cut into slices as per customer specifications. The above operation in this example yielded an expanded composite honeycomb block 601 with a density of, for example, approximately 4 pounds per cubic foot (pcf) with a cell size of approximately 4.8 mm.

The foregoing examples have been provided merely for the purpose of explanation and are in no way to be construed as limiting of the method and the apparatus 100 disclosed herein. While the method and the apparatus 100 have been described with reference to various embodiments, it is understood that the words, which have been used herein, are words of description and illustration, rather than words of limitation. Further, although the method and the apparatus 100 have been described herein with reference to particular means, materials, and embodiments, the method and the apparatus 100 are not intended to be limited to the particulars disclosed herein; rather, the method and the apparatus 100 extend to all functionally equivalent structures, methods and uses, such as are within the scope of the appended claims. Those skilled in the art, having the benefit of the teachings of this specification, may effect numerous modifications thereto and changes may be made without departing from the scope and spirit of the method and the apparatus 100 disclosed herein in their aspects.

I claim:

1. An apparatus for a continuous manufacture of an expanded composite honeycomb block, the apparatus comprising:
a heated bed with a corrugated surface;
a conformable thin membrane moving over the heated bed, proximal to the corrugated surface of the heated bed, wherein resin impregnated fibers are iteratively deposited over the conformable thin membrane;
a vacuum pump, in fluid communication with a space between the heated bed and the conformable thin membrane via a vacuum port, for iteratively pulling the conformable thin membrane along with the resin impregnated fibers on the corrugated surface of the heated bed to allow the conformable thin membrane with the resin impregnated fibers to conform to a shape of the corrugated surface of the heated bed and create corrugated resin impregnated fibers; and
a stacker positioned above the heated bed, the stacker configured to be lowered iteratively to adhere to and pick up the corrugated resin impregnated fibers positioned over the conformable thin membrane, whereby the stacker iteratively stacks layers of the corrugated resin impregnated fibers to manufacture the expanded composite honeycomb block.

2. The apparatus of claim 1, wherein the resin impregnated fibers are fibers comprising one of glass fibers, carbon fibers, aramid fibers, thermoplastic fibers, and any combination thereof, impregnated with resin.

3. The apparatus of claim 2, wherein the resin is one of a phenolic resin, an epoxy resin, a polyimide resin, a cyanate ester resin, a bismaleimide resin, and a polyester resin.

4. The apparatus of claim 1, wherein the conformable thin membrane is a silicone rubber sheet reinforced with unidirectional fibers, and wherein the unidirectional fibers comprise one of glass fibers, carbon fibers, aramid fibers, thermoplastic fibers, and any combination thereof.

5. A method for a continuous manufacture of an expanded composite honeycomb block, the method comprising:
depositing resin impregnated fibers on a conformable thin membrane, wherein an upper surface of the resin impregnated fibers is exposed to air and a lower surface of the resin impregnated fibers is in flush contact with the conformable thin membrane;
moving the conformable thin membrane along with the resin impregnated fibers over a heated bed, proximal to a corrugated surface of the heated bed;
applying a vacuum between the conformable thin membrane and the heated bed for pulling the conformable thin membrane along with the resin impregnated fibers on the corrugated surface of the heated bed to allow the conformable thin membrane with the resin impregnated fibers to conform to a shape of the corrugated surface of the heated bed and create corrugated resin impregnated fibers;
lowering a stacker to contact the corrugated resin impregnated fibers on top nodes of the corrugated surface of the heated bed;
heat curing the corrugated resin impregnated fibers;
raising the stacker to lift the heat cured corrugated resin impregnated fibers after the heat cured corrugated resin impregnated fibers release from the conformable thin membrane; and
repeating the above steps until the stacker stacks layers of the heat cured corrugated resin impregnated fibers to a desired thickness to manufacture an expanded composite honeycomb block of the desired thickness.
